(19) United States
(12) Patent Application Publication
(10) Pub. No.: US 2026/0150814 A1
(43) Pub. Date: Jun. 4, 2026

(54) COLLAPSIBLE FEEDING SYSTEM

(71) Applicants: Zemua Baptista, Ulysses, NE (US); Paixao Baptista, Ulysses, NE (US)

(72) Inventors: Zemua Baptista, Ulysses, NE (US); Paixao Baptista, Ulysses, NE (US)

(21) Appl. No.: 19/177,330

(22) Filed: Apr. 11, 2025

Related U.S. Application Data
(60) Provisional application No. 63/633,352, filed on Apr. 12, 2024.

(51) Int. Cl. A01K 39/012

(52) U.S. Cl. CPC A01K 39/0125

(57) ABSTRACT

A collapsible feed system comprising a hopper sub-system, a flange, an upper mounting ring, and a cross beam. The hopper sub-system comprising a collapsible sidewall configured to transition between a stored and deployed configuration. The flange being adapted to couple to a distribution line for dispensing bulk material. The system further comprising a cable assembly for raising the hopper sub-system for storage and lowering the hopper sub-system for dispensing bulk material.

### CROSS-REFERENCE TO OTHER APPLICATIONS

The present application is related to and claims priority from: U.S. Application Ser. No. 63/633,352, titled COLLAPSIBLE FEEDING SYSTEM, filed Apr. 12, 2024. U.S. application Ser. No. 63/633,352 is herein incorporated by reference in its entirety

### INTRODUCTION

In many industries, efficient handling of bulk materials is paramount to productivity and cost-effectiveness. Feed hopper systems play a crucial role in this process, serving as containers for storing and dispensing various materials such as grains, powders, or pellets. However, traditional feed hopper systems often present challenges, particularly when it comes to detachable feeding tubes. When these hoppers are raised or moved, the feeding tube often needs to be detached, leading to disruptions and inefficiencies in the material handling process.

For example, poultry floor feeding systems are typically suspended from ceilings and utilize conduits to distribute food to feeding containers located below. These conduits often span considerable distances and service numerous feeding containers. When these feeding systems are lowered, hoppers play a crucial role in facilitating the distribution of food to these feeding trays. Subsequently, a distribution system within the hopper serves to dispense the food into the feeding trays. However, a common challenge arises during a transition of the system from a deployed configuration to a stored configuration. In many instances, the hoppers either need to be removed entirely or the feeding tube must be detached due to space constraints, rendering this removal and reinstallation process time-consuming and inefficient.

Thus, there is a growing demand for collapsible feed hopper systems that not only address the fundamental storage and dispensing needs but also offer enhanced flexibility and convenience, especially in scenarios where space optimization and ease of transport are essential considerations. Therefore, there exists a need for an application, system, and method which cures one or more of the shortfalls of previous approaches identified above.

### SUMMARY

In some aspects, the techniques described herein relate to a collapsible feed system including: a collapsible container having: a first opening located at a top portion of the collapsible container; a second opening located at a bottom portion of the collapsible container; a collapsible sidewall providing a circumferential boundary to the collapsible container; a channel disposed between the first opening and the second opening; and a flexible inner ring coupled to a circumferential inner surface of the collapsible sidewall located adjacent to the second opening; a flange coupled to the bottom portion of the collapsible container including: a planar base; a cylindrical tube; and a flange channel extending through the planar base and the cylindrical tube, wherein the cylindrical tube is adapted for insertion into the second opening and wherein the planar base is located at least partially outside the channel; an upper mounting ring coupled to the collapsible container adjacent to the top portion and at least partially surrounding an outer surface of the collapsible sidewall; and a cross beam coupled to the upper mounting ring at a first contact position and a second contact position, wherein the cross beam extends across the first opening.

In some aspects, the techniques described herein relate to a feed distribution system including: a hopper sub-system including: a collapsible container including: a first opening located at a top portion of the collapsible container; a second opening located at a bottom portion of the collapsible container; a collapsible sidewall providing a circumferential boundary to the collapsible container; a channel disposed between the first opening and the second opening; and a flexible inner ring coupled to a circumferential inner surface of the collapsible sidewall located adjacent to the second opening; a flange coupled to the bottom portion of the collapsible container including: a planar base; a cylindrical tube; and a flange channel extending through the planar base and the cylindrical tube, wherein the cylindrical tube is adapted for insertion into the second opening and wherein the planar base is located at least partially outside the channel; an upper mounting ring coupled to the collapsible container adjacent to the top portion and at least partially surrounding an outer surface of the collapsible sidewall; a cross beam coupled to the upper mounting ring at a first contact position and a second contact position, wherein the cross beam extends across the first opening; a boot coupled to the flange configured to control release of a bulk material from the collapsible container; a feed source storing the bulk material; and a feeding tube reversibly coupled to the feed source and the hopper sub-system including: a first end configured to receive the bulk material from the feed source; and a second end configured for selective insertion into the channel for dispensing the bulk material into the collapsible container.

In some aspects, the techniques described herein relate to a method of distributing bulk material, the method including: providing a hopper sub-system, the hopper sub-system including: a collapsible container having: a first opening located at a top portion of the collapsible container; a second opening located at a bottom portion of the collapsible container; a collapsible sidewall providing a circumferential boundary to the collapsible container; a channel disposed between the first opening and the second opening; and a flexible inner ring coupled to a circumferential inner surface of the collapsible sidewall located adjacent to the second opening; a flange coupled to the bottom portion of the collapsible container including: a planar base; a cylindrical tube; and a flange channel extending through the planar base and the cylindrical tube, wherein the cylindrical tube is adapted for insertion into the second opening and wherein the planar base is located at least partially outside the channel; an upper mounting ring coupled to the collapsible container adjacent to the top portion and at least partially surrounding an outer surface of the collapsible sidewall; and a cross beam coupled to the upper mounting ring at a first contact position and a second contact position, wherein the cross beam extends across the first opening; instructing attachment of the hopper sub-system to at least one cable configured to transition the hopper sub-system from a stored configuration to a dispensing configuration; instructing attachment of the hopper sub-system to at least one bulk material distribution line; instructing placement of a feeding tube inside the channel, wherein the feeding tube is coupled to a bulk material source; and instructing dispensing of bulk material from the bulk material source.

### BRIEF DESCRIPTION OF THE DRAWINGS

The numerous advantages of the disclosure may be better understood by those skilled in the art by reference to the accompanying figures in which:

FIG. 1A illustrates a first perspective view of a collapsible feeding system, in accordance with one or more embodiments of the present disclosure;

FIG. 1B illustrates a second perspective view of a collapsible feeding system, in accordance with one or more embodiments of the present disclosure;

FIG. 1C illustrates a third perspective view of a collapsible feeding system, in accordance with one or more embodiments of the present disclosure;

FIG. 2A illustrates a perspective view of an assembled hopper sub-assembly, in accordance with one or more embodiments of the present disclosure;

FIG. 2B illustrates a perspective view of a pre-formed collapsible container of a hopper sub-assembly, in accordance with one or more embodiments of the present disclosure;

FIG. 2C illustrates a perspective view of a formed collapsible container of a hopper sub-assembly, in accordance with one or more embodiments of the present disclosure

FIG. 2D illustrates a perspective view of a flange of a hopper sub-assembly, in accordance with one or more embodiments of the present disclosure;

FIG. 2E illustrates a perspective view of a cross beam of a hopper sub-assembly, in accordance with one or more embodiments of the present disclosure;

FIG. 2F illustrates a perspective view of a hopper sub-assembly in a collapsed configuration, in accordance with one or more embodiments of the present disclosure;

FIG. 3A illustrates a first perspective view of a feeding tube integrated within the collapsible feeding system, in accordance with one or more embodiments of the present disclosure;

FIG. 3B illustrates a second perspective view of a feeding tube integrated within the collapsible feeding system, in accordance with one or more embodiments of the present disclosure;

FIG. 3C illustrates a first perspective view of a feeding tube integrated within the collapsible feeding system, in accordance with one or more embodiments of the present disclosure;

FIG. 4 illustrates a perspective view of the collapsible feeding system in a stored configuration, in accordance with one or more embodiments of the present disclosure; and

FIG. 5 is a flowchart depicting a method of use, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Reference will now be made in detail to the subject matter disclosed, which is illustrated in the accompanying drawings.

Embodiments of the present disclosure are directed to curing one or more of the shortfalls of previous approaches identified above. Embodiments of the present disclosure are directed to a collapsible feeding system. In particular, embodiments of the present disclosure are directed to a feed system configured to collapse, using a minimal amount of durable material, into a stored configuration, offering enhanced efficiency and convenience in poultry floor feeding operations. Furthermore, embodiments of the present disclosure provide for flexibility in adaptive use, allowing a hopper sub-system to be paired with a plurality of distribution feeding lines. Even further, embodiments of the present disclosure provide for an all-in-one system, wherein the hopper sub-system may be raised and lowered along with a distribution line, removing unnecessary steps of removing a hopper after each feeding.

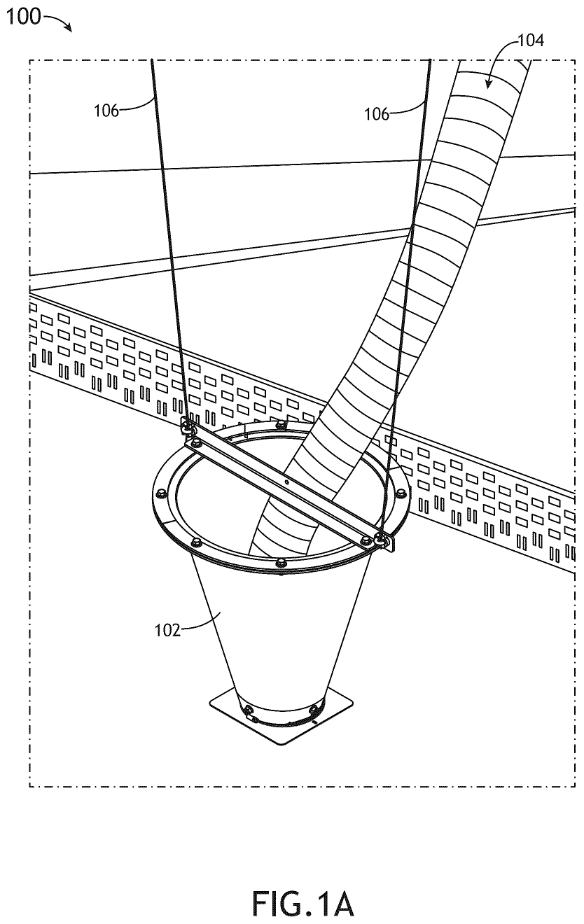

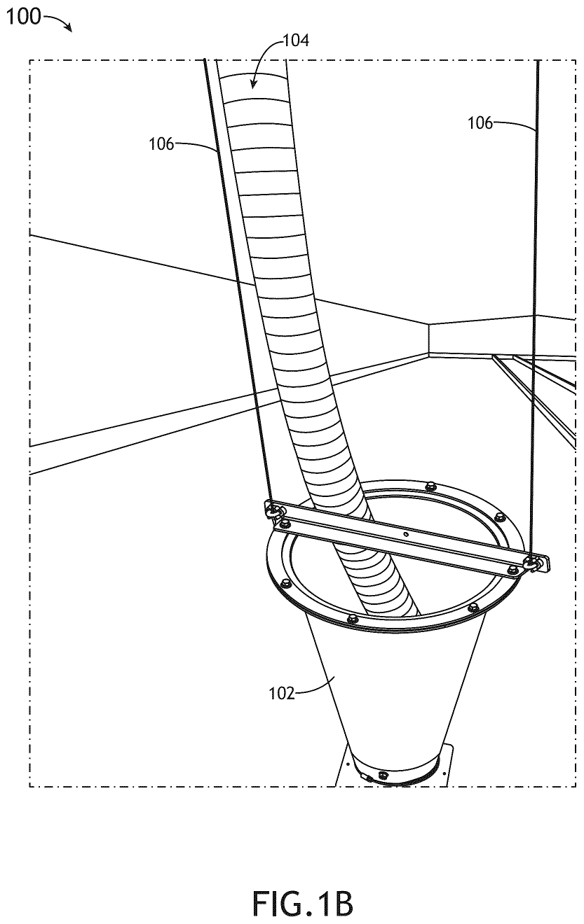

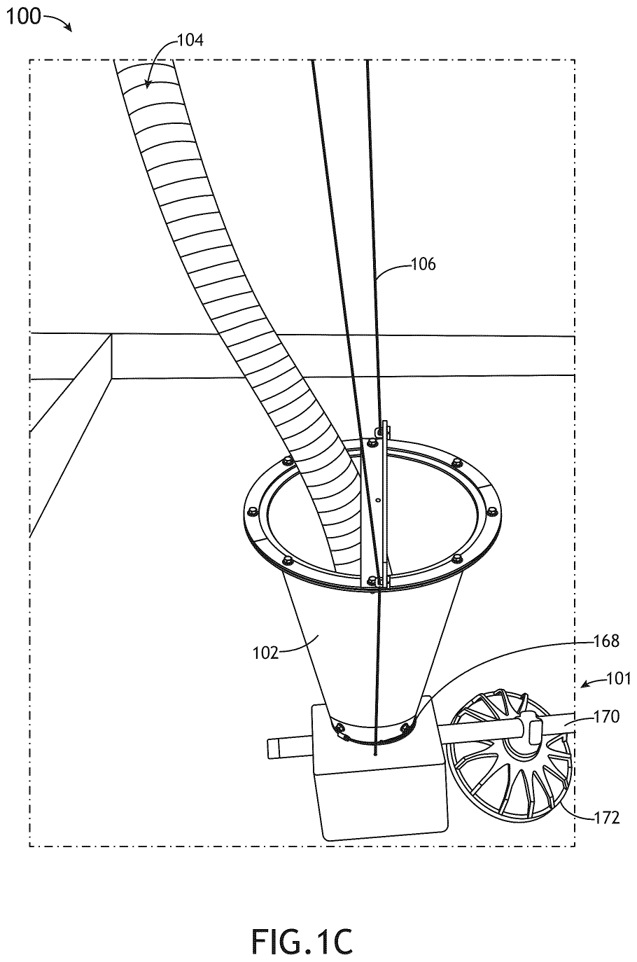

Referring generally to FIGS. 1A-4, various perspective views of the collapsible feeding system 100 are illustrated, in accordance with one or more embodiments of the present disclosure. The collapsible feeding system 100 may include at least one of a hopper sub-system 102, a feeding tube 104, and a cable assembly 106. In embodiments, the collapsible feeding system 100 may further be coupled to one or more distribution lines 101 (as depicted in FIG. 1C) when in a deployed configuration, with the one or more distribution lines 101 being configured to deploy dry bulk, or other animal feed.

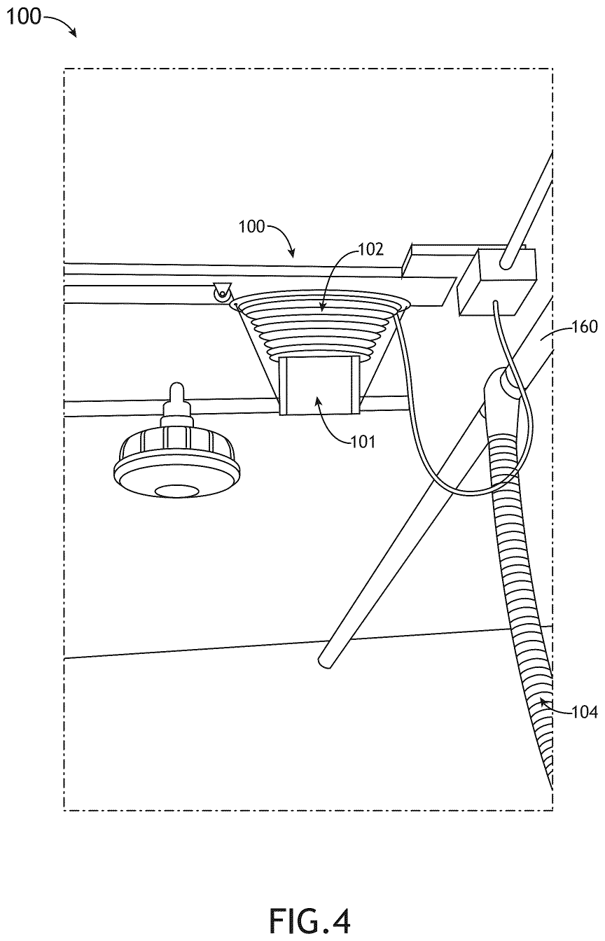

In embodiments, the feeding system 100 transitions between a deployed configuration and a stored configuration (as depicted in FIG. 4). It is noted herein that while the feeding system 100 is in the stored configuration, one or more components of the feeding system 100 may at least be partially raised or suspended above the distribution line 101.

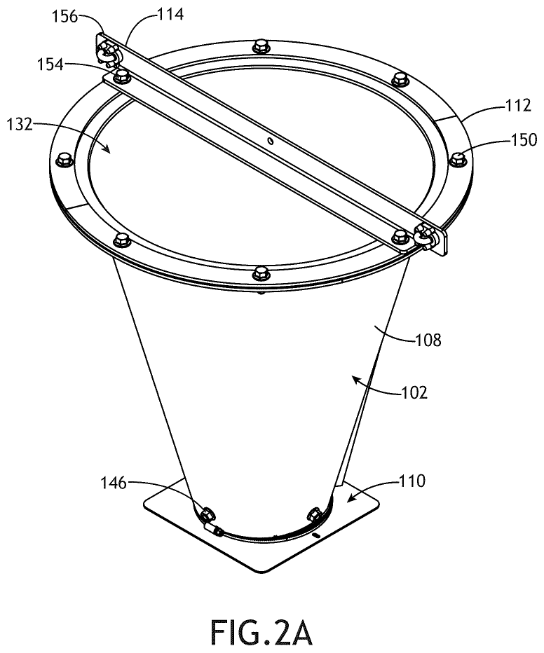

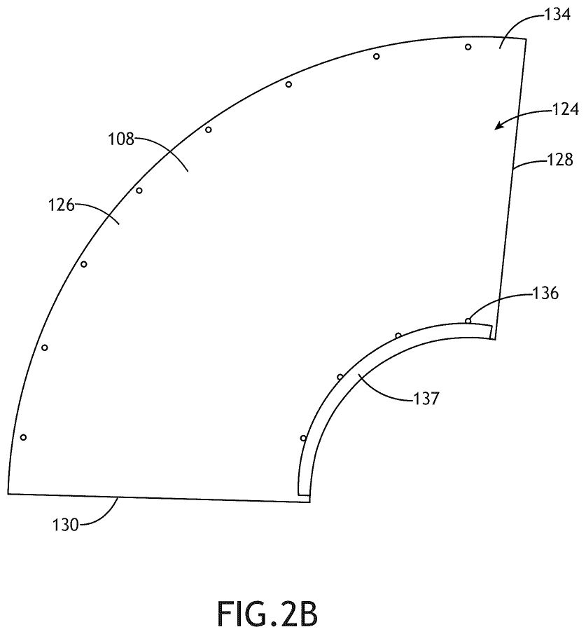

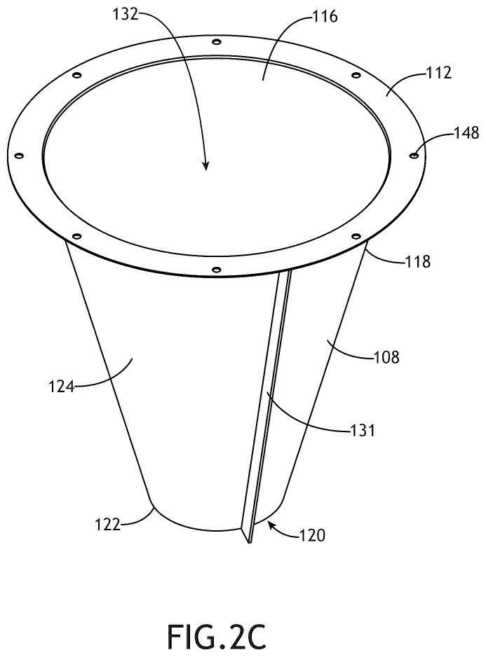

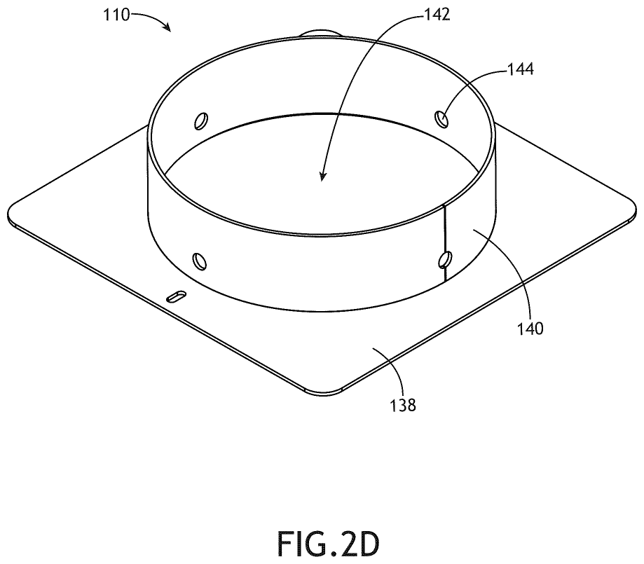

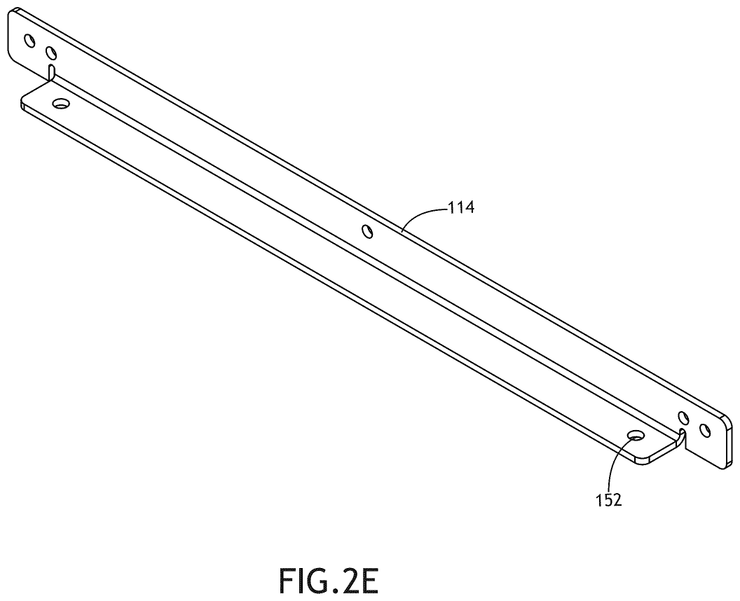

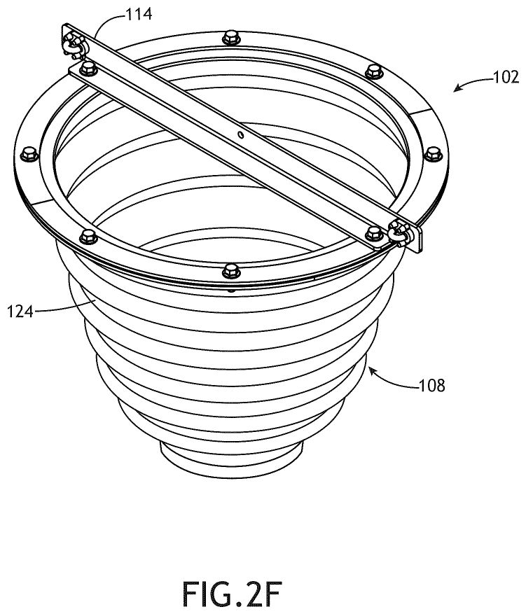

FIG. 2A depicts a perspective view of an exemplary embodiment of the hopper sub-system 102, which includes a collapsible container 108, a flange 110, an upper mounting ring 112, and a cross beam 114. In embodiments, the collapsible container 108 is a storage container configured for receiving bulk material from feeding tube 104, aiding in eventual disbursement via the distribution system.

In embodiments, and as depicted in FIG. 2A, a formed collapsible container 108 comprises a first opening 116 located at a top portion 118 of the collapsible container 108 and a second opening 120 located at a bottom portion 122 of the collapsible container 108. Furthermore, when formed, a collapsible sidewall 124 is located between the first opening 116 and the second opening 120, with the collapsible sidewall 124 providing a circumferential boundary to the collapsible container 108.

In embodiments, the height of the collapsible container 108 may vary, and for example, may be dependent on factors such as the volume requirements associated with the livestock being fed. For example, the collapsible container 108 may comprise an overall height of approximately 21 inches. However, the dimensions of the collapsible container 108 may be selectively controlled to be as tall or short as desired.

As shown in FIG. 2B, a perspective view of an unformed collapsible container, in embodiments, the collapsible sidewall 124 is formed from a single piece of material 126 whereby the piece of material 126 is folded in a manner that a first portion 128 of the material 126 is overlaid over a second portion 130, such that the first portion 128 overlaps a portion of the of the second portion 130. Once the first portion 128 is overlaid over the second portion 130, a sealing method may be formed thereby fastening the first portion 128 and the second portion 130 together via a seam 131. Accordingly, in embodiments, the collapsible container 108 is sealed via the seam 131 extending along a vertical height of the collapsible sidewall 124 corresponding to an area of overlapping material 126. In embodiments, the sealing method may be a permanent sealing, including for example, heat sealing or sewing, thereby permanently affixing first portion 128 and second portion 130 together. In further embodiments, the sealing method may be a reversible sealing method, including for example, zippers or hook and loop fasteners. In further embodiments, the material used to form collapsible container 108 may vary, allowing for different methods of collapsing. For example, in embodiments, the collapsible container may be constructed form a plastic or other hardened material, wherein the method of collapsing is telescopic or a nesting of a smaller diameter section of material into a larger diameter section of material.

FIG. 2C depicts a perspective view of a formed collapsible container 108. In embodiments, when formed, the collapsible container 108 comprises a tapered design, wherein the first opening 116 comprises a larger circumference than the second opening 120. For example, in embodiments, the first opening 116 comprises a circumference of approximately 2 inches to 8 inches and the second opening 120 comprises a circumference of approximately 1 inch to approximately 6 inches. However, in further embodiments, the collapsible container 108 may comprise varying designs, including embodiments in which first opening 116 and second opening 120 comprise uniform sizes, or even further embodiments in which first openings 116 is larger than second opening 120. Furthermore, the specific dimensions of each of the first opening 116 and/or the second opening 120 may vary and may comprise any selected dimensions, which may, for example, be dependent on the distribution line 101 and/or the feeding tube 104.

In embodiments, and when formed, the collapsible container 108 further comprises a channel 132 disposed between the first opening 116 and the second opening 120 that extends the length of the collapsible sidewall 124. As described herein, the channel 132 is configured for temporarily holding bulk material that is received from the feeding tube 104 prior to dispensing via the distribution line 101.

In embodiments, the collapsible sidewall 124 further comprises one or more fastener openings. As described herein, the one or more fastener openings may be adapted for receiving fasteners, screws, clamps, or other mechanical fasteners for securing one or more components of the hopper sub-system 102. Depending on the embodiment, the one or more openings may be selectively positioned and/or varied in number. For example, in the exemplary embodiment depicted in FIG. 2B, the collapsible sidewall 124 comprises a first plurality of openings 134 located approximate to the top portion 118 and a second plurality of openings 136 located approximate to the bottom portion 122.

In embodiments, the hopper sub-systems 102 may optionally and/or further comprise a flexible inner ring 137. The flexible inner ring 137 may be positioned and secured adjacent and/or approximate to the second opening 120 and located along an inner surface of the collapsible sidewall 124. In embodiments, the flexible inner ring 137 circumferentially surrounds the second opening 120. The flexible inner ring 137 may provide a flexing effect that may, for example, aid in securing the collapsible container to the flange 110. Accordingly, the flexible inner ring 137 may be constructed from neoprene or other similar, flexible material. For example, in embodiments, the flexible inner ring 137 comprises a width of approximately 1 inch and a thickness of approximately ⅛ inch. However, the flexible inner ring 137 may comprise any pre-selected dimensions.

In embodiments, the hopper sub-system 102 further comprises a flange 110. FIG. 2D depicts a perspective view of an exemplary embodiment of the flange 110. As described herein, when assembled, the flange 110 is coupled to the collapsible container 108 approximate to the bottom portions 122 and second opening 120. The flange 110 acts as a coupling mechanism for the hopper sub-system 102 and the distribution line 101 for the distribution of bulk material after the bulk material has passed through the collapsible container 108.

As depicted in FIG. 2D, the flange 110 comprises a planar base 138, cylindrical tube 140, and a flange channel 142. In embodiments, the planar base 138 is a substantially flat piece of material that provides a receiving point to coupling the hopper sub-system 102 to the distribution line 101. The design of the planar base 138 may vary depending on the implementation of the hopper sub-system 102 and/or the distribution line 101. In the exemplary embodiment in FIG. 2D, the planar base 138 comprises a rectangular design. However, the planar base 138 can comprise any geometric shape, dimensions, and/or thickness for coupling to the distribution line 101. Further, in embodiments, the planar base comprises a length and width of approximately 8.75 inches. However, the dimensions of the planar base 138 may vary, and for example, may be dependent on the dimensions of an attachment point with the distribution line 101. Furthermore, the hopper sub-system 102 may utilize a plurality of flanges 110 with varying sizes and/or configurations of the planar base 138, allowing the hopper sub-system 102 to be paired with a variety of distribution lines 101.

In embodiments, the cylindrical tube 140 is a tubular piece of material extending away from the planar base 138. The cylindrical tube 140 is adapted for insertion into the channel 132 via second opening 120. Accordingly, the cylindrical tube 140 comprises a length that is great enough to be inserted and nest within channel 132. For example, the cylindrical tube may comprise a height of approximately 1.875 inches. Furthermore, cylindrical tube 140 comprises a geometric design adapted for insertion through second openings 120. For example, in the depicted embodiment, cylindrical tube 140 comprises a circular design corresponding to the circular design of the second opening 120. However, in embodiments in which second opening 120 comprises differing geometric shapes, cylindrical tube 140 likewise comprises a corresponding geometric shape.

As further depicted in FIG. 2D, the flange 110 comprises a flange channel 142. The flange channel 142 is a void space or opening that provides a continuous opening through the length of the flange 110, including the entire length of the cylindrical tube 140 and through the planar base 138. In embodiments, bulk material passes through the flange channel 142 after passing through the collapsible container 108.

In embodiments, including the exemplary embodiment depicted in FIG. 2D, the flange 110 further comprises one or more flange openings 144. As described herein, the flange openings 144 are adapted and configured to provide a coupling point between the flange 110 and the collapsible container 108. In embodiments, the flange openings 144 are defined into the cylindrical tube 140. Furthermore, the flange openings 144 may be defined in the cylindrical tube 140 in corresponding number and/or positions in relation to the second plurality of openings 136 located approximate to the bottom portion 122 of the collapsible container 108. For example, after insertion into the second opening 120, the one or more flange openings 144 and the second plurality of openings 136 can line up to provide a continuous opening for receiving one or more flange fasteners 146. When one or more flange fasteners 146 are inserted, coupling between the flange 110 and the collapsible container 108 occurs. In embodiments, the flange fasteners 146 are hex bolts, however, the flange fasteners 146 may be any mechanical fasteners as understood in the art.

As depicted in FIG. 2A, embodiments of the hopper sub-system 102 further comprises at least one upper mounting ring 112. In embodiments, the upper mounting ring 112 is a fixture or component located and coupled to the top portion 118 of the collapsible container 108. The upper mounting ring 112 may be at least one piece of material that surrounds the outer surface of the collapsible sidewall 124. For example, the upper mounting ring 112 may be a ring of ASTM A36 wrapped around and coupled to the top portion 118. However, the upper mounting ring 112 may be manufactured or constructed from other similar materials.

In embodiments, the upper mounting ring 112 further comprises one or more coupling openings 148 defined into the material of the upper mounting ring. The one or more coupling openings 148 may be selectively positioned and/or numbered to correspond to the first plurality of openings 134. To couple the upper mounting ring 112 to the collapsible container 108, one or more upper mounting ring fasteners 150 may be utilized. Similar to securing the flange 110 to the collapsible container 108, the one or more upper mounting ring fasteners 150 may be inserted into the one or more coupling openings 148 and the first plurality of openings 134. The upper mounting ring fasteners 150 may be hex bolts however, any known mechanical fastener may be utilized.

As further depicted, upper mounting ring 112 further comprises a plurality of cross beam openings 152, collectively positioned along the circumference of the upper mounting ring 112. Like the one or more coupling openings 148, the plurality of cross beam openings 152 are defined through the upper mounting ring 112 and provide an opening to accept fasteners for coupling the cross beam 114 to the collapsible container 108. In embodiments, each opening of the plurality of cross beam openings 152 may be selectively positioned to allow for selective placement of the cross beam 114, allowing for flexibility and ease of installation.

FIG. 2E is a perspective view depicting an exemplary embodiment of the cross beam 114. As depicted in FIG. 2E, the cross beam 114 is a rod, beam, or other piece of material that is coupled to the collapsible container 108, providing a secure attachment point for the cable assembly 106 to couple to the hopper sub-system 102. In embodiments, the cross beam 114 is positioned at the top portion 118, such that the cross beam 114 extends across the first opening 116. Furthermore, in embodiments, the cross beam 114 comprises an overall length that is greater than the diameter of the first opening 116, such that the cross beam 114 can be coupled to the upper mounting ring 112.

For coupling to the collapsible container 108, one or more mechanical fasteners 154 may be utilized. For example, the cross beam 114 may comprise one or more openings that line up with the plurality of cross beam openings 152. The one or more fasteners 154 can then be utilized in coupling the cross beam 114 to the upper mounting ring 112. In embodiments, the cross beam 114 comprises openings located on opposing ends that can be lined up with two opposing cross beam openings 152 located on the upper mounting ring 112. Accordingly, in embodiments, the cross beam 114 is coupled to the upper mounting ring 112 at a first contact position and a second contact position, wherein the cross beam 114 extends across the first opening 116. In this regard, the cross beam 114 can be selectively and removably placed and secured to the upper mounting ring 112.

In embodiments, the cross beam 114 further comprises one or more cable engagement members 156 for coupling the cross beam 114 to the cable assembly 106, and by extension, the hopper sub-system 102. For example, in embodiments, the cross beam 114 may comprise one or more wire rope clamps adapted for coupling to wire, ropes, cables, including for example the cables of the cable assembly 106. In embodiments, the one or more cable engagement members 156 may be selectively placed on the cross beam 114. For example, the cross beam 114 may comprise a single cable engagement member 156 located at the approximate center of cross beam 114. In further embodiments, the cross beam 114 comprises two cable engagement members 156 located at opposite ends of the cross beam 114. In even further embodiments, the one or more cable engagement members 156 may be optionally and/or further placed on the collapsible container 108, providing for additional connection points with the cable assembly 106.

As described in greater detail herein, when the hopper sub-system 102 is in the stored configuration, the collapsible container 108 is configured to collapse, fold, scrunch, crumple, or otherwise reduce its height, allowing for more efficient storage. An exemplary embodiment of the collapsible container 108 in the stored configuration is depicted in FIG. 2F. As depicted, in the stored configuration, the collapsible container 108 has been collapsed, thereby reducing the overall height of the hopper sub-system 102, allowing for more convenient storage. Accordingly, the collapsible sidewall 124 may be manufactured or formed out of a flexible material, including for example, a ballistic nylon material. However, the collapsible sidewall 124 may be manufactured out of any flexible material, including for example, cloth, polyester, rayon, or other similar materials.

In some embodiments, the hopper sub-system 102, and by extension the collapsible feeding system 100, may be further adapted and configured for use with one or more sensors. Non-limiting examples of sensors that can be utilized with hopper sub-system 102 include: capacitive sensors for monitoring and managing bulk material flow, precision livestock farming (PLF) sensor technologies, environmental sensors for gathering data related to the deployment environment, including sensors for temperature, humidity, motion, light, and gas sensors, or other sensors deployable in a smart agriculture setting. In embodiments, hopper sub-system 102 comprises one or more coupling points for securing the one or more sensors to. For example, additional openings may be defined into the collapsible sidewall 124, the upper mounting ring 112, the flange 110, and/or the cross beam 114. In further embodiments, additional mechanical fasteners, such as clamps or hooks may be selectively positioned on the collapsible container 108, the flange 110, the upper mounting ring 112, and/or the cross beam 114.

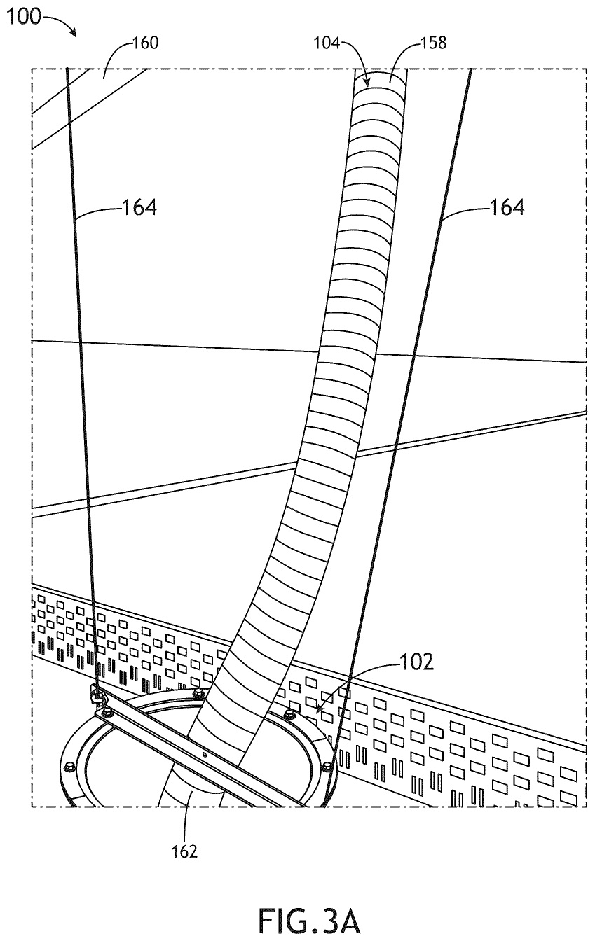

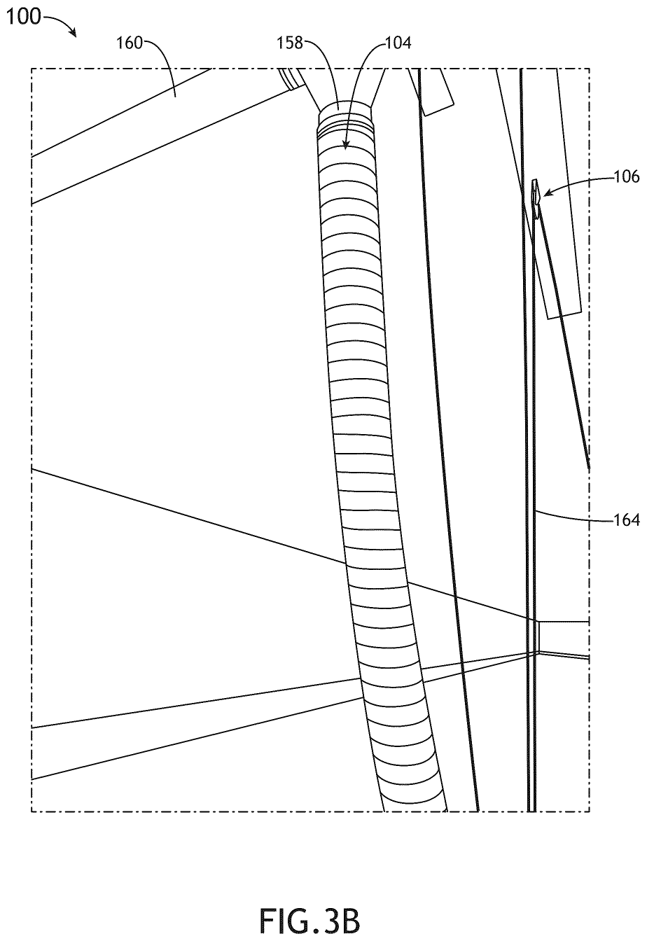

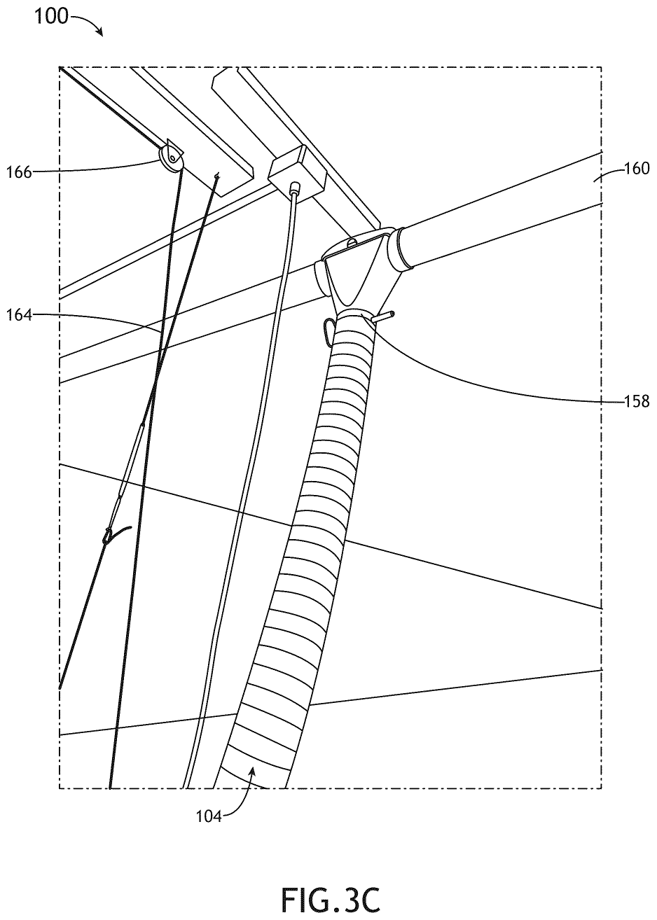

FIG. 3A depicts a perspective view of the feeding tube 104. As depicted in FIG. 3A, in embodiments, the collapsible feeding system 100 further comprises a feeding tube 104. The feeding tube 104 is configured to reversibly couple to the hopper sub-system 102. For example, a first end 158 of the feeding tube 104 may be configured to receive a bulk material from a feed source 160, and a second end 162 of the feeding tube 104 may be configured for dispensing of the bulk material into the hopper sub-system 102. The bulk material may include, but is not limited to, poultry feed. In embodiments, the first end 158 may be coupled to the feed source 160 using mechanical methods, including but not limited to worm-drive clamps. In embodiments, the second end 162 of the feeding tube 104 may be inserted into the channel 132 of the collapsible container 108 via first opening 116. Once inserted, the feeding tube 104 may be reversibly coupled to the hopper sub-system 102 prior to the dispensing of the bulk material into. For example, the feeding tube 104 may be coupled to the hopper sub-system 102 through a worm-drive clamp that can be secured around the cross beam 114. In further embodiments the interior of the collapsible container 108 may be fitted with an attachment point wherein a mechanical fastener can be used to couple the feeding tube 104 to the collapsible container 108.

In embodiments, the feeding tube 104 may be comprised of a flexible material (e.g., flexible plastic (polyvinyl chloride or polyethylene), rubber, fabric or textiles, composite materials (plastics, fibers, or metals), or the like) such that the feeding tube 104 may collapse into, or retract, a stored configuration alongside the hopper sub-system 102. For example, in embodiments, the feeding tube 104 is a self-retracting hose. In further embodiments, the feeding tube 104 may be constructed from a telescopic material, such as plastic or aluminum, in which the collapsing effect is telescopic.

FIGS. 3B and 3C depict a perspective view of the cable assembly 106 and the coupling between the feeding tube 104 and the feed source 160. As depicted in FIGS. 3B-C, in embodiments, the cable assembly 106 of the collapsible feeding system 100 features one or more cables 164 and a lift mechanism 166. The cable assembly 106 is utilized in transitioning the hopper sub-system 102 from the stored configuration (i.e., when the collapsible container 108 is in its collapsed state) to the deployed configuration (i.e., when the collapsible container 108 is expanded to its deployed state).

In embodiments, the one or more cables 164 comprise rope, wire, cords, cables, or the linkages that can be used to raise and lower the hopper sub-system 102. For example, a first end of the one or more cables 164 may be fixed to one or more structures (e.g., components of the lift mechanisms 166) suspended from the ceiling. By way of another example, a second end of the one or more cables 164 may be coupled to the hopper sub-system 102 via the one or more cable engagement members 156. The one or more cables 164 may be configured to raise or lower the hopper sub-system 102 in at least a linear direction.

In embodiments, the lift mechanism 166 is a mechanical system for raising and lowering the hopper sub-system 102, thereby transitioning it from the stored configuration to the deployed configuration. For example, the lift mechanism 166 may be a mechanical pully system with one or more wheels suspended from the ceiling that are used with the one or more cables 164. In a further example, the lift mechanism 166 may be an electronic lift system, utilizing a motor to raise and lower the hopper sub-system 102. However, any mechanical system for raising and lowering an object may be utilized by the collapsible feeding system 100.

As further depicted in FIGS. 1A-C and 3A-C, the collapsible feeding system 100 may be connected to both a feed source 160 and a distribution line 101, providing a fluid coupling between the feed source 160 and the distribution line 101. In embodiments, the feed source 160 comprises one or more distribution tubes or piping suspended from the ceiling, with bulk material (e.g., poultry feed) traveling through the piping. The feed source 160 further comprises one or more openings adapted for receiving the first end 158 of the feeding tube 104, as described above.

In embodiments, the distribution line 101 may comprise a boot 168, distribution piping 170, and one or more feed stations 172. In embodiments, the boot 168 and the flange 110 are adapted for mechanical coupling, thereby providing a fluid connection between the hopper sub-system 102 and the distribution line 101. The boot 168, for example, may include a mechanism such as, but not limited to, a slide or an auger configured to control the release of the bulk material from the hopper sub-system 102 to one or more feed stations 172 via distribution piping 170. By way of another example, through adjustment of the position of the slide or speed of the auger, the amount of material dispensed may be regulated by a user. In embodiments, the distribution line 101 may be affixed to hopper sub-system 102 such that when the hopper sub-system 102 is raised and lowered, the distribution line 101 is also raised and lowered. To aid in lifting and lowering the distribution line 101, the distribution line may further comprise one or more coupling points, allowing the cable assembly 106 to directly couple to the distribution line 101.

FIG. 4 depicts a perspective view of the collapsible feeding system 100 in the stored configuration. In embodiments, the transition of the hopper sub-system 102 may occur in response to a change of vertical positioning via the cable assembly 106. For example, when the hopper sub-system 102 is in the deployed configuration and located approximate to the ground, the collapsible container 108 is in its expanded configuration. As the hopper sub-system 102 is raised, the collapsible container 108 may remain in the expanded, deployed configuration until reaching the lift mechanism 166 and/or stowing location approximate to the ceiling. As the hopper sub-system 102 reaches its stowing position, the collapsible container 108 begins to collapse in response to either 1) coming in contact with the ceiling or other structure on the ceiling, and/or 2) in response to the distribution line 101 continuing to be raised after the hopper sub-system 102 has reached its terminal position. When the hopper sub-system 102 is lowered, the collapsible container 108 may begin to expand. Furthermore, in embodiments, the cable assembly 106 may also be manipulated to also cause expansion of the collapsible container 108.

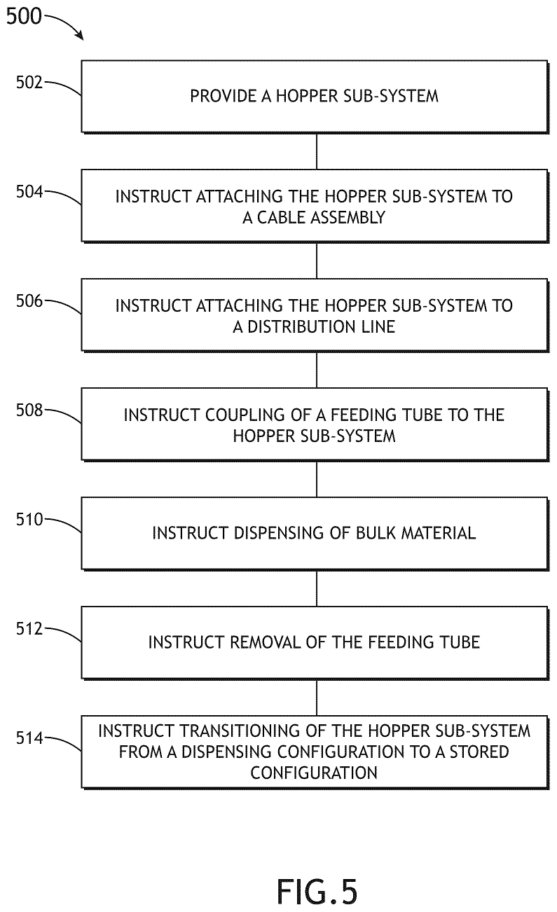

Turning now to FIG. 5, a method 500 of instructing use of the collapsible feeding system 100 is provided.

At step 502, the hopper sub-system 102 is provided. As described above, the provided hopper sub-system comprises the collapsible container 108, the flange 110, the upper mounting ring 112, and the cross beam 114.

At step 504, instruction for attaching the hopper sub-system 102 to the cable assembly 106 occurs. Instruction during this step can include coupling at least one of the one or more cables 164 to the one or more cable engagement members 156 of the hopper sub-system 102. In embodiments, step 504 occurs while the hopper sub-system 102 is located approximate to the ground.

At step 506, instruction for attaching the hopper sub-system 102 to the distribution line 101 occurs. Instruction during this step can include coupling the flange 110 to the boot 168 of the distribution line 101.

At step 508, instruction of coupling the feeding tube 104 to the hopper sub-system 102 occurs. Instruction during this step includes instructing placement of the second end 162 of the feeding tube 104 into the channel 132. Step 508 may optionally and further comprise instructing mechanical fastening of the feeding tube 104 to the collapsible container 108 via one or more mechanical fasteners. In the event that the feeding tube 104 is not previously coupled to the feed source 160, step 508 may optionally also include instruction coupling of the first end 158 to the feed source 160.

At step 510, instruction of dispensing bulk material from the feed source 160 occurs. During this step, bulk material may fluidly pass from the feed source 160, through the feeding tube 104, through the hopper sub-system 102, and into the distribution line 101.

At step 512, instruction of removing the feeding tube 104 from the hopper sub-system 102 occurs. For example, after a pre-determined amount of bulk material has been dispersed, the feeding tube 104 may be removed in preparation of transitioning the hopper sub-system 102 from the deployed configuration to the stored configuration.

At step 514, instruction of transitioning the hopper sub-system 102 from the dispensing configuration to the stored configuration occurs. During this step, instruction of using the cable assembly 106 to raise the hopper sub-system 102 from the ground to the storing location approximate to the ceiling occurs. Accordingly, in embodiments, the hopper sub-system is stored at a higher vertical position while in the stored configuration than while in the dispensing configuration

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A collapsible feed system comprising:
a collapsible container having:
a first opening located at a top portion of the collapsible container;
a second opening located at a bottom portion of the collapsible container;
a collapsible sidewall providing a circumferential boundary to the collapsible container;
a channel disposed between the first opening and the second opening; and
a flexible inner ring coupled to a circumferential inner surface of the collapsible sidewall located adjacent to the second opening;
a flange coupled to the bottom portion of the collapsible container comprising:
a planar base;
a cylindrical tube; and
a flange channel extending through the planar base and the cylindrical tube,
wherein the cylindrical tube is adapted for insertion into the second opening and wherein the planar base is located at least partially outside the channel;
an upper mounting ring coupled to the collapsible container adjacent to the top portion and at least partially surrounding an outer surface of the collapsible sidewall; and
a cross beam coupled to the upper mounting ring at a first contact position and a second contact position, wherein the cross beam extends across the first opening.

2. The collapsible feed system of claim 1, wherein the collapsible container is constructed from a ballistic nylon material.

3. The collapsible feed system of claim 2, wherein the collapsible container is manufactured from a single piece of the ballistic nylon material, wherein a first end of the ballistic nylon material overlaps a second end and sealed.

4. The collapsible feed system of claim 3, wherein the collapsible container is sealed via a seam extending along a vertical height of the collapsible sidewall corresponding to an area of overlapping ballistic nylon material.

5. The collapsible feed system of claim 1, wherein the flexible inner ring is constructed from neoprene.

6. The collapsible feed system of claim 5, wherein the flexible inner ring comprises a width of approximately 1 inch and a thickness of approximately ⅛ inch.

7. The collapsible feed system of claim 1, wherein the upper mounting ring comprises a plurality of openings for selective and removable placement of the cross beam.

8. The collapsible feed system of claim 1, wherein the cross beam further comprises at least one receiving point for attaching to at least one cable.

9. The collapsible feed system of claim 8, wherein the cross beam comprises a first receiving point located a first terminal end and a second receiving point located at a second terminal end.

10. The collapsible feed system of claim 1, wherein the collapsible sidewall further comprises a first set of openings configured for receiving a plurality of fasteners,
wherein the cylindrical tube further comprises a corresponding second set of openings configured for receiving the plurality of fasteners to couple the flange to the collapsible container.

11. The collapsible feed system of claim 1, wherein the planar base comprises a length of 8.75 inches and a width of 8.75 inches and wherein the cylindrical tube comprises a height of 1.875 inches.

12. The collapsible feed system of claim 1, further comprising:
a lower mounting ring that at least partially surrounds the collapsible sidewall approximate to the bottom portion for aiding in securing the flange in position when inserted into the channel.

13. The collapsible feed system of claim 1, wherein the collapsible sidewall tapers from the first opening to the second opening.

14. A feed distribution system comprising:
a hopper sub-system comprising:
a collapsible container comprising:
a first opening located at a top portion of the collapsible container;
a second opening located at a bottom portion of the collapsible container;
a collapsible sidewall providing a circumferential boundary to the collapsible container;
a channel disposed between the first opening and the second opening; and
a flexible inner ring coupled to a circumferential inner surface of the collapsible sidewall located adjacent to the second opening;
a flange coupled to the bottom portion of the collapsible container comprising:
a planar base;
a cylindrical tube; and
a flange channel extending through the planar base and the cylindrical tube,
wherein the cylindrical tube is adapted for insertion into the second opening and wherein the planar base is located at least partially outside the channel;
an upper mounting ring coupled to the collapsible container adjacent to the top portion and at least partially surrounding an outer surface of the collapsible sidewall; and
a cross beam coupled to the upper mounting ring at a first contact position and a second contact position, wherein the cross beam extends across the first opening;
a feed source storing bulk material; and
a feeding tube reversibly coupled to the feed source and the hopper sub-system comprising:
a first end configured to receive the bulk material from the feed source; and
a second end configured for selective insertion into the channel for dispensing the bulk material into the collapsible container.

15. The feed distribution system of claim 14, further comprising a boot coupled to the flange configured to control release of a bulk material from the collapsible container, wherein the boot further comprises a slide or an auger for controlling the release of bulk material.

16. The feed distribution system of claim 14, wherein the feeding tube is a self-retracting hose.

17. A method of distributing bulk material, the method comprising:
providing a hopper sub-system, the hopper sub-system comprising:
a collapsible container having:
a first opening located at a top portion of the collapsible container;
a second opening located at a bottom portion of the collapsible container;
a collapsible sidewall providing a circumferential boundary to the collapsible container;
a channel disposed between the first opening and the second opening; and
a flexible inner ring coupled to a circumferential inner surface of the collapsible sidewall located adjacent to the second opening;
a flange coupled to the bottom portion of the collapsible container comprising:
a planar base;
a cylindrical tube; and
a flange channel extending through the planar base and the cylindrical tube,
wherein the cylindrical tube is adapted for insertion into the second opening and wherein the planar base is located at least partially outside the channel;
an upper mounting ring coupled to the collapsible container adjacent to the top portion and at least partially surrounding an outer surface of the collapsible sidewall; and
a cross beam coupled to the upper mounting ring at a first contact position and a second contact position, wherein the cross beam extends across the first opening;
instructing attachment of the hopper sub-system to at least one cable configured to transition the hopper sub-system from a stored configuration to a dispensing configuration;
instructing attachment of the hopper sub-system to at least one bulk material distribution line;
instructing placement of a feeding tube inside the channel, wherein the feeding tube is coupled to a bulk material source; and
instructing dispensing of bulk material from the bulk material source.

18. The method of claim 17, wherein the collapsible sidewall comprises a flexible material to allow for the collapsible sidewall to collapse while in the stored configuration.

19. The method of claim 17, further comprising:
following dispensing of bulk material, instructing removal of the feeding tube from the channel; and
instructing transitioning of the hopper sub-system from the dispensing configuration to the stored configuration.

20. The method of claim 19, wherein the hopper sub-system is stored at a higher vertical position while in the stored configuration than while in the dispensing configuration.
